(19) United States
(12) Patent Application Publication
(10) Pub. No.: US 2021/0179884 A1
(43) Pub. Date: Jun. 17, 2021

(54) REDOX CHASED SUSPENSION BEAD ADDITIVES FOR PAINTS AND STAINS

(71) Applicant: Columbia Insurance Company, Omaha, NE (US)

(72) Inventors: Shi-Jun Yang, Maple Glen, PA (US); Yong Yang, Hillsborough, NJ (US); Kevin Lee, North Brunswick, NJ (US); George Amrich, Hackettstown, NJ (US)

(21) Appl. No.: 16/717,059

(22) Filed: Dec. 17, 2019

(51) Int. Cl. C09D 133/12; C09D 5/02; C09D 7/40; C09D 7/42

(52) U.S. Cl. CPC C09D 133/12; C09D 5/028; C09D 7/42; C09D 7/68; C09D 7/70

(57) ABSTRACT

Disclosed herein is a paint or stain aqueous composition comprising an optional opacifying pigment, a film forming latex resin and a redox-chased suspension bead preferably having an unreacted monomer amount of less than about 1,000 ppm. The redox-chased suspension bead preferably has a particle size (Dn) ranging from about 1 μm to about 45 μm, and the redox-chased suspension bead preferably comprises from about 3 wt. % to about 20 wt. % of the total polymer weight of the aqueous composition, and the redox-chased bead is non-film forming and is free of stripping.

### FIELD OF THE INVENTION

The present invention relates to paint additives such as matting agents or flattening agents polymerized by suspension polymerization technique that have the odors associated therewith substantially removed to be used in architectural compositions, such as paints and stains.

### BACKGROUND OF THE INVENTION

Polymers are polymerized from monomers by several known polymerization techniques, including solution polymerization, bulk or mass polymerization, suspension polymerization and emulsion polymerization, among others. Each type of polymerization can produce polymers having different chemical and mechanical properties.

In solution polymerization, monomers, initiator(s) and the resulting polymers are all soluble in the solvent or solvent blend. For free radical polymerization, the rate of the reaction is directly proportional to the monomer concentration. Generally, solution polymerization starts with more than 70% monomer concentration. More solvent is added as the polymerization progresses to regulate viscosity, and additional initiator/catalyst can be added to regulate the reaction rate. Pure polymer can be obtained after removing the solvent. The rate of polymerization is lower than that of emulsion polymerization and the amount of residual monomers is higher, which can cause odors and high volatile organic compounds (VOC). Solution polymerization is generally used when the resulting polymers are used as solvent-based coatings or as pressure sensitive adhesive. (See e.g., http://polymerdatabase.com/polymer %20chemistry/Solution %20Polymerization.html).

In mass or bulk polymerization, the reaction mixture contains mainly of monomers and polymerization is carried out in undiluted monomers. In the case of vinyl polymers, the reaction occurs with vinyl monomers and dissolved initiator(s). Since there is no solvent or diluent present in the reaction mixture, mass or bulk polymerization produces polymers with higher molecular weight and requires no further purification. Mass or bulk polymerization also produces 100% solid resin. However, this polymerization is not always practical due to very exothermic reactions and the reaction temperature is difficult to control, especially at the later stage of the polymerization when viscosity is higher. Additionally, the increased viscosity with increasing molecular weight can hinder the removal of volatile byproducts such as water. In mass polymerization, the polymer is insoluble in the monomer in later stage of polymerization and precipitates. This distinguish mass or bulk polymerization from dispersion polymerizations, such as emulsion polymerization and suspension polymerization, discussed below. (See e.g., http://polymerdatabase.com/polymer%20chemistry/Bulk%20Polymerization.html).

Suspension polymerization, which is also known as bead, pearl or granular polymerization, is essentially a water- or solvent-cooled bulk polymerization. Suspension polymerization uses water as the continuous phase, which acts as an effective heat transfer medium and is more environmentally friendly than solution polymerization. Suspension polymerization typically occurs in a dispersing medium (water), monomer(s) that are relatively insoluble in the dispersing medium, stabilizing agents and a monomer soluble initiator. Initiators are mostly monomer soluble peroxides (e.g., benzoyl, t-butyl, diacetyl and lauryl peroxide) and azo compounds (e.g., azobisisobutyronitrile or AIBN). Typical stabilizers include surfactants (e.g., sodium, potassium or ammonium salts of fatty acids) that lowers the surface tension and dispersing agents (e.g., polyelectrolytes and inorganic salts) that provide a surface charge. Known stabilizers include water soluble non-micelle-forming polymers such as methyl or ethyl cellulose and poly(vinyl alcohol). Suspension polymerization is carried out in small droplets of liquid monomers and consists of initiation, propagation and termination, similar to those of the bulk polymerization albeit on smaller scale. During polymerization the immiscible droplets slowly convert from a liquid to a sticky, viscous material and upon reaching sufficiently high molecular weight form solid, rigid particles. The particle size of suspension polymer particles typically ranges from about 0.1 mm (100 μm) to about 5 mm and is significantly larger, e.g., one or two orders of magnitude, than emulsion polymer particles. (See e.g., http://polymerdatabase.com/polymer%20chemistry/Suspension%20Polymerization.html).

Emulsion polymerization system comprises in a dispersing medium (water), monomers, emulsifier, initiator and optional modifiers. Water is the continuous phase and the other components are dispersed by the emulsifiers. The monomers form droplets that are suspended and stabilized by the emulsifiers and form micelles that surround a small amount of monomers. The remaining monomers are dispersed in small droplets. Commonly used emulsifiers include anionic (e.g., sodium, potassium or ammonium salts of fatty acids, and C₁₂-C₁₆ alkyl sulfates) and nonionic surfactants (e.g., poly(ethylene oxide), and protective colloids, such as poly(vinyl alcohol) and hydroxyl cellulose). Emulsion polymerization can generally be divided into three stages.

In stage I, the mixture consists of the continuous water phase with dispersed surfactant micelles and emulsified small monomer droplets. Most of the monomers are in these emulsified droplets and some are dissolved in the micelles. Monomers in the active micelles are consumed and are replenished through diffusion with monomers from the monomer droplets through the water phase. The particle number and reaction rate increase with time. In Stage II, the surfactants have been absorbed and initiators have been consumed by the polymeric particles. The particles number and reaction rate are substantially constant. In Stage III, the size of the latex particles increases and the size of the monomer droplets decreases and eventually disappears. The reaction mixture consists of monomer swollen polymer particles or latex particles and dissolved monomers. The reaction ends when all monomers are used up. If no termination occurs for example by a radical diffuses into polymer particles, the polymerization reaches essentially 100%. The latex particles typically have spherical shape and a diameter from 50 nm-300 nm, which is significantly smaller than the size of suspension polymeric particles. (See e.g., http://polymerdatabase.com/polymer%20chemistry/Emulsion%20Polymerization.html).

While suspension and emulsion polymerizations are commercially used to manufacture polymers, there are significant differences between these two commercial processes. In emulsion polymerization, the initiator is soluble in the aqueous phase, and in suspension polymerization, the initiator is dissolved in the monomer phase. See F. W. Billmeyer, Textbook of Polymer Science, 3^{rd} Ed., Wiley-Interscience Publication (1984), pp. 128-132. Emulsion produces latex particles in the order of 0.1 μm or 100 nm, which are ideal for film-forming resins in paints, stains and other architectural compositions. Suspension produces significantly larger polymeric particles or beads that can be readily washed and dried and are used for molding solid plastic articles. See Id and U.S. Pat. No. 7,067,188. Another difference is that in emulsion polymerization the vast majority of the monomers are polymerized, and in suspension polymerization a significant number of unreacted monomers remain. As discussed in commonly owned U.S. Pat. No. 8,507,579, residual monomers cause a significant malodourous problem. The odors do not generally become a problem when suspension beads are molded to make solid plastic articles and the unreacted monomers are locked within the plastic articles or residual monomers are removed through secondary extrusion step during fabrication, but would cause a problem in paints and stains. For this reason, suspension beads with the odorous issue are not typically used in architectural compositions such as paints and stains without significant post-polymerization treatments making them unfeasible.

European published patent application No. 1 834 995 disclose using a matting agent (1-20 μm particle size) made by suspension polymerization, but does not address the odor problem associated with the polymerization of the matting beads. EP 3 124 229 discloses another matting agent (˜40 μm particle size) made by suspension polymerization used in the coating of metal surfaces, but also does not address the odor problem.

U.S. Pat. No. 6,353,087 discloses a process for redox chasing and then stripping a dispersion polymer to remove the VOC and gel. In Example 1, after a conversion of 90%-99.99% of ethylenically unsaturated monomer to polymer, the polymer was cooled to 60° C. 80 ml of a charge promoter solution (0.15% FeSO₄.H₂O) was added to the batch and stirred for about 15 minutes. An oxidizing solution of 8 g of tertiary butyl hydroperoxide in 56 ml of water was added to the batch and stirred for about 15 minutes. A reducing solution containing 8 g of isoascorbic acid in 160 ml of water was added to the batch and stirred for about 15 minutes.

The '087 patent reports that the redox chasing process in Example 1 was insufficient to remove the VOC/unreacted monomers from the polymer dispersion, and after the redox chasing the VOC/unreacted monomers level remain at 1205 ppm. VOC/unreacted monomer level was not reduced below 100 ppm until a stripping step was conducted, which is discussed in the Abstract as adjusting the pH to 7-11 and maintaining the pH during stripping and maintaining temperature of the polymer from 30° C. to 70° C. The stripping step may last up to 3 hours and required additional stripping equipment, as discussed in the '579 patent, unlike the chasing step which could be done using the polymerization equipment.

Hence, there remains a need for a simpler way to render suspension matting agents or beads substantially odorless by reducing the level of unreacted monomers with less post-polymerization processing and equipment, so that it can be use in paints, stains and other architectural compositions.

### SUMMARY OF THE INVENTION

Hence, an embodiment of the invention is directed to a paint or stain aqueous composition comprising an optional opacifying pigment, a film forming latex resin and a redox-chased suspension bead preferably having an unreacted monomer amount of less than about 1,000 ppm. The redox-chased suspension bead preferably has a particle size (Dn) ranging from about 1 μm to about 45 μm, and the redox-chased suspension bead preferably comprises from about 3 wt. % to about 20 wt. % of the total polymer weight of the aqueous composition, and the redox-chased bead is non-film forming.

The particle size of the redox-chased suspension bead can range from about 5 μm to about 35 μm, from about 10 μm to about 30 μm or in one embodiment from about 8 μm to about 12 μm. The redox-chased suspension bead may have an unreacted monomer amount of less than about 900 ppm, less than about 800 ppm or less than about 500 ppm, and lower. The redox-chased suspension bead may comprise from about 4 wt. % to about 17 wt. % of the total polymer weight of the aqueous composition or from about 7 wt. % to about 14 wt. % of the total polymer weight of the aqueous composition.

Another embodiment of the present invention is directed to a paint or stain aqueous composition comprising an optional opacifying pigment, a film forming latex resin, and a redox-chased, suspension bead. The redox-chased suspension bead has particle size (Dn) ranging from about 1 μm-about 45 μm, and the redox-chased bead preferably comprises from about 3% to about 20% of the total polymer weight of the aqueous composition, and wherein the redox-chased bead is non-film forming. Preferably, the paint of stain composition comprises an unreacted monomer amount of less than about 350 ppm if the film forming latex resin comprises substantially acrylic latex particles, or the paint of stain composition comprises an unreacted monomer amount of less than about 2,000 ppm if the film forming latex resin comprises vinyl acrylic latex particles.

The paint or stain composition may comprise an unreacted monomer amount of less than about 325 ppm if the film forming latex resin comprises substantially acrylic latex particles, or the paint or stain composition may comprise an unreacted monomer amount of less than about 1,750 ppm if the film forming latex resin comprises vinyl acrylic latex particles. The paint or stain composition may comprise an unreacted monomer amount of less than about 300 ppm if the film forming latex resin comprises substantially acrylic latex particles, or the paint or stain composition comprises an unreacted monomer amount of less than about 1,500 ppm if the film forming latex resin comprises vinyl acrylic latex particles.

The redox-chased suspension bead is preferably a matting agent.

Preferably, the redox-chased, suspension bead and the film forming latex resin are compatible with each other. More preferably, the redox-chased, suspension bead and the film forming latex resin both comprise at least one acrylic monomer, and are miscible with each other.

### DETAILED DESCRIPTION OF THE PREFERRED EMBODIMENTS

One embodiment of the present invention is directed to preparing matting agents by a suspension polymerization technique, which produces relatively large polymeric particles, preferably from about 1 μm to about 45 μm, preferably from about 5 μm to about 35 μm and preferably from about 10 μm to about 30 μm. The particle size is measured by optical microscopy. Several different areas are measured for particle sizes. A size value is assigned to each particle or the weight of each particle within the distribution is counted equally. Hence, the particles sizes reported herein are based on number distribution or Dₙ as reported herein. The particle size is reported herein as a range from D₁₀ to D₉₀, wherein about 10% of particles falls below the D₁₀ size and about 90% of the particles falls above the D₉₀ size. For example, particle size from about 1 μm to about 45 μm means that about 10% of the particles are smaller than 1 μm and about 90% of the particles are smaller than 45 μm. See Horiba Scientific's Guidebook to Particle Size Analysis (2014). (See www.horiba.com/us/particle.) Alternatively, the particle size can be determined by passing the latex particles through a filtering mesh at D₉₀ and another filtering mesh at D₁₀. The bead particles that pass through the D₉₀ but not the D₁₀ mesh would be the beads whose sizes fall between D₁₀ and D₉₀.

The glass transition temperature (Tg) is preferably higher than 60° C., more preferably greater than about 75° C. or 100° C. and less than about 125° C., or sufficiently hard to be effective matting agents. Hence, the suspension polymeric particles or beads are non-film forming at indoor or outdoor environment. As used herein Tg are calculated pursuant to the Fox's equation unless indicated otherwise. Due to the nature of bulk polymerization discussed above, the amount of residual unreacted monomers is high. This presents a malodorous problem for suspension beads and limits their use in architectural coatings, such as stains and paints.

Heretofore, there have been limited efforts to remove unreacted monomers from suspension polymers for reasons discussed above. Some efforts, such as those described in the '087 patent, require both a redox chasing step and a steam stripping step to remove VOC or neutralize unreacted monomers from dispersion polymers. The present inventors have devised a novel method to simplify the neutralization of unreacted monomers and the associated odors from suspension polymers to a single step. In one preferred embodiment, the suspension polymers are chased with a redox (reducing agent and oxidation agent) pair for a sufficient amount of time to substantially reduce the odor and to neutralize the unreacted monomers without performing the lengthy or time-consuming stripping step and requiring additional stripping equipment. The present inventors believe that the redox pair neutralize the unreacted monomers on the surfaces of the suspension polymers.

Suitable oxidizing agents include but are not limited to water-soluble hydroperoxides, tertiary butyl hydroperoxide, cumene hydroperoxide, hydrogen peroxide, sodium peroxide, potassium peroxide, sodium perborate, potassium persulfate, sodium persulfate, ammonium persulfate, persulfuric acid and salts thereof, perphosphoric acid and salts thereof, potassium permanganate, and an ammonium or alkali salt of peroxydisulfuric acid. A preferred oxidizing agent is tertiary butyl hydroperoxide (tBHP).

Suitable reducing agents include but are not limited to sodium formaldehyde sulfoxylate (SFS), ascorbic acid, isoascorbic acid, organic compounds containing thiol or disulfide groups, reducing inorganic alkali and ammonium salts of sulfur-containing acids, such as sodium sulfite, disulfite, thiosulfate, hydrosulfite, sulfide, hydrosulfide or dithionite, formadinesulfinic acid, hydroxymethanesulfonic acid, acetone bisulfite, amines, such as ethanolamine, glycolic acid, glyoxylic acid hydrate, lactic acid, glyceric acid, malic acid and tartaric acid. A preferred reducing agent is a formaldehyde-free SFS.

Preferably, the redox chasers utilized is from about 0.01 wt. % to about 1.0 wt. %, preferably from about 0.05 wt. % to about 0.75 wt. %, preferably from about 0.1 wt. % to about 0.5% of all monomers.

Preferably, the amount of suspension beads/matting agent in the paint formulations is from about 3 wt. % to about 20 wt. % of the paint formulation and more preferably from about 4 wt. % to about 17 wt. % of the paint formulation, and more preferably from about 7 wt. % to about 13 or 14 wt. %.

According to another aspect of the present invention, a functional moeity can be polymerized onto the suspension beads that can impart additional functionality or functionalities to the suspension beads. A first functional moiety includes but is not limited to one or more dimethylamino functional monomers having the following formula:

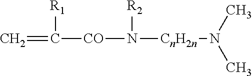

wherein R₁ represents hydrogen or methyl; R₂ represents hydrogen or C1-6 alkyl and n is 2 to 6. These monomers can be co-polymerized with the other monomers to impart a functionality to the suspension beads. Suitable monomers for such first functional moeity include but are not limited to N,N-dimethylamino ethyl acrylate, N-2-N,N-dimethylamino ethyl methacrylamide, N-3-N,N-dimethylamino propyl acrylamide, N-3-N,N-dimethylamino propyl methacrylamide, N,N-dimethylamino ethyl methacrylate (DMAEMA), N,N-diethylamino ethyl acrylate, N,N-diethylamino ethyl methacrylate, N-t-butylamino ethyl acrylate, N-t-butylamino ethyl methacrylate, N,N-dimethylamino propyl acrylamide, N,N-dimethylamino propyl methacrylamide (DMAPMAA), N,N-diethylamino propyl acrylamide, N,N-diethylamino propyl methacrylamide. Preferred first moeity includes dimethylamino propylmethacrylamide (DMAPMA) or N-[3-(Dimethylamino)propyl]methacrylamide (DMAPMAA).

Other suitable first monomers are disclosed in US 2014/0121146 (paragraph [0042]), US 2015/0374634 (paragraph [0123]), US 2009/0269406 (paragraph [0034]), U.S. Pat. No. 7,319,117 (cols. 11 and 17). These references are incorporated herein in their entireties.

A second functional moeity may be provided by copolymerizing a polymerizable low molecular weight, high acid number dispersant that is dissolvable in an alkali solution, commercially available as Joncryl™ from BASF, Morcryl™ from DOW and Tamol™ from DOW. Such copolymerization is discussed in commonly owned U.S. Pat. No. 8,895,658, which is incorporated herein by reference in its entirety.

A third functional moeity may be provided by copolymerizing a polymerizable allyl phosphate surfactant commercially available as ERS-1684 available from ETHOX Chemicals and discussed in U.S. Pat. No. 9,051,341 and also in commonly owned U.S. Pat. No. 9,453,133, which are incorporated herein by reference in their entireties.

A fourth functionality may be provided by polymerizable glycols, such as methoxy polyethylene glycol (MPEG) or polypropylene glycol methyl ether (MPPG) copolymerized to the suspension beads. Such polymerizable glycols are discussed in U.S. Pat. No. 5,610,225, which is incorporated herein by reference in its entirety.

Other additional functionalities and monomers that can be copolymerized with the monomers that form the suspension beads are within the scope of the present invention.

The following non-limiting examples illustrate the novel chased suspension polymeric spheres or beads suitable for use in paints or stains.

EXAMPLE 1. Into a 5-liter round bottom flask reactor equipped with digital agitator, temperature controller and nitrogen purge, 2000 g of DI water was charged together with 40 g of polyvinyl alcohol and 4.2 g of sodium (C₁₄-C₁₆) olefin sulfonate. The temperature was raised to 73° C. with N₂ purge and agitation until the polyvinyl alcohol was completely dissolved. In a separate Erlenmeyer flask, the following components were mixed with a magnet stirrer bar until all ingredients were dissolved.

| Chemical ingredients | Weight parts |
|---|---|
| methyl methacrylate monomer | 430.0 |
| styrene monomer | 18.0 |
| butanediol diacrylate | 1.2 |
| (cross-linking agent) | |
| n-dodecylmercaptan (n-DDM) | 0.8 |
| (chain transfer agent) | |
| azobisisobutyronitrile (AIBN) | 1.2 |
| (initiator) | |
| lauroyl peroxide (initiator) | 2.4 |
| sodium C9-22 alkyl sec sulfonate | 0.4 |
| (surfactant, emulsifier) | |

Slowly the above monomer mixture was charged into the reactor at 73° C. in about 5-10 minutes while maintaining the agitation speed at about 350-400 RPM. The reactor temperature was maintained at 73-75° C. If necessary, a few drops of antifoaming agent could be added to suppress the foam throughout the reaction. After about 2 hours of heating and after an exothermal peak was observed, the heating temperature was raised to about 82° C. for another 2 hours to complete the reaction. After cooling the batch to 60-65° C., the suspension polymer particles were chased by adding 2.0 g of tertiary-butyl hydroperoxide and 1.5 g of formaldehyde-free SFS redox pairs to the batch for at least 2 hours to reduce the monomer odors of suspension beads for the architecture coatings application. Without this chasing step, the monomer odors from suspension beads would be prohibitive for use in architecture coating such as paints and stains. Because the suspension reaction is a bulk polymerization process, the residual monomer of final polymer beads is generally high from about 0.3 wt. % to about 1.2 wt. %. The redox chasing step renders suspension beads substantially odor free for use with architecture coatings.

The redox chasers were diluted in deionized water to about 10% concentration and were added in two parts into the reactor after the reaction temperature dropped to below 62° C. The agitation continued for at least 2 hours before samples were taken for analysis of VOC and unreacted monomers. The samples in Example 1 were rested and analyzed the next day which would result in slightly lower VOC reading, as discussed below.

The suspending beads can be separated with either centrifugal or precipitation methods and the beads were dried for incorporating into paint or stain formulations. The suspension beads had a narrow particle size distribution. A majority of beads were normally less than 45 μm, and particles larger than 45 μm were removed through filtering.

EXAMPLE 2. In a container, 35 g of polyvinyl alcohol was dissolved in 2000 g DI water, and 1200 g of this suspending solution was mixed with following monomer composition and agitated for about 45 seconds with an IKA® Turrax T25 mixer at 11000 RPM to form desired small particle droplets. The monomer mixture was then transferred into the reactor setup described in Example 1. The remaining 835 g of the suspending solution was added slowly into monomer mixture with agitation at 180 RPM and this RPM agitation was maintained through the remaining reaction. The temperature was raised and set at 79° C. for 2.5 hours, at 82° C. for another 1.5 hours and then cooled down to room temperature. The exothermal peak appeared at about 1-hour mark. Sample was taken from the reactor for residual monomer analysis. The particle size distribution from this batch was between about 1 μm to about 37 μm, and substantially all of the particle sizes were measured from about 8 μm to about 12 μm.

| Chemical Ingredients | Weight Parts |
|---|---|
| MMA | 520.0 |
| styrene | 80.0 |
| butanediol diacrylate | 1.5 |
| n-dodecylmercaptan (n-DDM) | 0.5 |
| AIBN | 1.6 |
| lauroyl peroxide (initiator) | 3.4 |
| secondary-sodium alkyl sulfonates | 0.5 |
| (average 15-carbon chain length) | |

The residual monomers measured by a headspace gas chromatograph (GC) was about 0.26% (2570 ppm MMA, and less than 25 ppm styrene). The dry particles had strong monomer odor, which is not suitable for consumer product applications.

The above suspension polymerization was repeated exactly the same way, and the suspension beads are treated with a chasing step using a redox pair, formaldehyde free SFS and t-butyl hydroperoxide, to eliminate the monomer odors. 1.2 parts of each redox pair (formaldehyde-free SFS and tBHP) was mixed with 10 parts of DI water separately, and divided into two portions of about 5 ml each, which were then added to the reactor at 70° C. and 50° C. sequentially. The cooling was applied while maintain agitation for about 2-4 hours. The samples taken at the end of the reaction before the addition of the chasers, and after have following residual monomers. The dry particles after chaser treatment have no monomer odors and are suitable for application of consumer products, such as paints and stains. Redox chasing treatment was effective to remove residual monomers on the surface of the suspension beads.

| | Total | Residual | Residual |
|---|---|---|---|
| | chasers | monomers | monomers |
| | conc. vs. | before | after |
| Compositions | monomers | chasers | chasers |
| MMA/Styrene/ | 0.40% | 0.26% | 184 ppm |
| x-linker | (2.4 parts/600 parts) | (2,595 ppm) | |
| Dry particles | | Strong | No |
| Odor | | | discernable |
| | | | odor |

The total chaser concentration vs. monomers is the total weight of the chasers (tBHP and formaldehyde-free SFS) divided by the total weight of the monomers and multiplied by 100%.

EXAMPLE 3. In a vessel containing 2000 g of DI water and 2% polyvinyl alcohol solution, the following monomer mix was added and agitated with a magnetic stirrer plate at its highest RPM, which was about 2,500 rpm, for about 15 minutes to reach desired monomer droplets size. A functional monomer, e.g., DMAPMA discussed above, was included in the monomer mix. The monomer/suspending solution mixture was then transferred into a round bottom reactor disclosed in Example 1. The reaction was completed according to the suspension polymerization process described above and cooled down to room temperature. Particle size from this batch was between 5-30 μm and residual monomer before the redox pair chase was about 0.26% (2560 ppm). The sample was also collected after 1.5 parts of each redox pair (formaldehyde free SFS/tBHP) mixed with 10 parts of DI water and added in two portions in sequence to the batch, which was agitated for another 90 minutes to reduce residual monomers. The monomer residuals after the redox chaser treatment of 90 minutes are 795 ppm of MMA and less than 25 ppm of styrene. Holding the chasing step for 90 minutes appear to neutralize less of the unreacted monomers than holding for a longer time period as reported above if the other factors are similar. However, the chaser concentration was higher and that could reduce the chased period. For suspension polymerization, the expected or normal range of unreacted monomers was from 2,000 ppm to 5,000 ppm. Hence, the roughly 820 ppm of residual monomers from Example 3 show a marked improvement. The dry particles have no strong monomer odor, which was suitable for application in consumer product, such as paints or stains.

| | Weight |
|---|---|
| Chemical Ingredients | parts |
| MMA | 518 |
| styrene | 80 |
| dimethylamino propylmethacrylamide | 19 |
| (DMAPMA) | |
| n-dodecylmercaptan (n-DDM) | 0.4 |
| lauroyl peroxide (initiator) | 3.3 |
| 2,2 azobis(2methylpropionitrile) | 1.4 |
| (initiator) | |
| secondary sodium alkyl sulfonate | 0.5 |
| (average 15-carbon chain length) | |

| | Total | Residual | Residual |
|---|---|---|---|
| | chasers conc. | monomers | monomers |
| Compositions | vs. monomers | before chasers | after chasers |
| MMA/Styrene/ | 0.50% | 0.26% | 820 ppm |
| DMAPMA | (3 parts/617 | (2,560 ppm) | |
| | parts) | | |
| Dry particles Odor | | Strong | No discernable odor |

EXAMPLE 4. This example was substantially the same as Example 1. The chemical ingredients were also the same except that styrene was replaced by ethyl acrylate, as shown below.

| | Weight |
|---|---|
| Chemical ingredients | parts |
| methyl methacrylate monomer | 430.0 |
| ethyl acrylate monomer | 20.0 |
| butanediol diacrylate | 1.2 |
| n-dodecylmercaptan (n-DDM) | 0.8 |
| azobi si sobutyronitrile (AIBN) | 1.2 |
| lauroyl peroxide (initiator) | 2.4 |
| sodium C9-22 alkyl sec sulfonate | 0.4 |

The suspension beads are also chased with a redox pair as discussed above.

EXAMPLE 5. This example s was substantially the same as Example 1. The chemical ingredients were also the same except that styrene was omitted, and butanediol diacrylate was replaced by allyl methacrylate, as shown below.

| | Weight |
|---|---|
| Chemical ingredients | parts |
| methyl methacrylate monomer | 450.0 |
| allyl methacrylate | 1.2 |
| n-dodecylmercaptan (n-DDM) | 0.8 |
| azobisisobutyronitrile (AIBN) | 1.2 |
| lauroyl peroxide (initiator) | 2.4 |
| sodium C9-22 alkyl sec sulfonate | 0.4 |

The suspension beads are also chased with a redox pair as discussed above.

The binder resins for the architectural coatings such as paints and stains are preferably made using the emulsion polymerization technique discussed above. Emulsion polymerization produces latex particles having particle sizes preferred for architectural coatings. The Examples below show emulsion latex particles made according to conventional emulsion polymerization methods.

EXAMPLE 6. In a container, 40 parts of polyvinyl alcohol (PVA), 3.2 parts of sodium dodecylbenzene (branched) sulfonate, and 0.5 parts of secondary sodium alkyl sulfonate (average carbon chain length 15) were dissolved in 1960 parts of deionized water. The premixed monomers in the following table were added into this PVA solution with agitation of about 2500 rpm for 20-25 minutes to reach desired size of monomer droplets. The total monomer mixture was then transferred into a 5 L reactor described in Example 1 and heated to 75.5° C. to start the conversion. The reactor was agitated at 385 rpm for a few minutes and then reduced to 325 rpm for the rest of the polymerization. After 2.5 hours at 75.5° C. and exothermal peak, the temperature was raised to 76.5° C. for 1 hour, and then to 82° C. for additional 1.5 hours, and then cool down to 60° C. Before the redox treatment, a sample was taken for residual monomer analysis at the end of the reaction. The redox pair (formaldehyde free SFS/tBHP), at 0.15 wt. % of each (vs. monomers) were added into the reactor separately in two portions and cooled to room temperature. Samples were taken after 0.5 hour and 15 hours redox treatment for residual monomer analysis. The sample treated for 30 minutes still have mild monomer odors, but the sample treated long time, for example 15 hours, was completely odor free.

| Compositions | Parts |
|---|---|
| MMA | 337 |
| styrene | 108 |
| 1,4 butanediol diacrylate (cross-linker) | 1.2 |
| nDDM (chain transfer agent) | 0.6 |
| AIBN (initiator) | 0.7 |
| lauroyl peroxide (initiator) | 1.28 |

The largest particle size from this batch was less than about 38 μm inspected by an optical microscope on several samples from this batch, which was suitable for desirable surface properties for paint formulations. The residual monomers of the samples taken at different times before and after redox treatment are listed in the following table. The residuals were analyzed by a headspace GC method according to ASTM standards, such as ASTM D6886, ASTM D3960, ASTM D4526 and ASTM D-2369 standards.

| | | Control | | |
|---|---|---|---|---|
| | Total Chasers | (no Redox treatment) | Redox | Redox |
| | Conc. vs. total | Sample at end of | treatment | treatment |
| Sample | monomers | reaction | for 30 min | for 15 hours |
| Residual MMA-- | 0.30% | 0.45%--120 ppm | 0.14%--12 ppm | 0.08%--8 ppm |
| Styrene | | (4,620 ppm total) | (1,412 ppm total) | (808 ppm total) |
| Monomer Odors | N/A | strong odors | mild odors | odor free |

From examples 2, 3 and 6, redox chasers are shown to decrease the remaining unreacted monomers at various initial unreacted monomers, various concentrations and chased times. A summary is shown below

| | Unreacted | | | Total |
|---|---|---|---|---|
| | monomers | | | residual |
| | before the | Chaser | Chased | unreacted |
| | chased step | concentration | time | monomers |
| Example 2 | 2,595 ppm | 0.40% | 2-4 hours | 184 ppm |
| Example 3 | 2,560 ppm | 0.50% | 1.5 hours | 820 ppm |
| Example 6 | 4,620 ppm | 0.30% | 0.5 hour | 1,412 ppm |
| Example 6 | 4,620 ppm | 0.30% | 15 hours | 808 ppm |

The period of chased times depends on the initial amounts of unreacted monomers and chaser concentration relative to the total amount of monomers. In accordance with one aspect of the present invention, preferably the amount of residual unreacted monomers in the suspension beads after the chased step and without having to perform a stripping step is less than 1,000 ppm, more preferably less than about 900 ppm, less than about 800 ppm, less than about 500 ppm or less than about 400 ppm, 300 ppm or 200 ppm. Also, preferably the concentration of total chasers relative to total monomers is greater than about 0.30%, preferably greater than about 0.40% or greater than about 0.60%.

RESIN 1. Into a 5-liter 4-neck round bottom glass reactor equipped with a digital mechanic stirrer, a thermocouple, a condenser, and nitrogen purge, 732.0 g of deionized (DI) water, 1.5 g of NaHCO₃, and 2.0 g of emulsifier, such as sodium dodecyl (branched) benzene sulfonate, were added and heated to 79° C. Into an Erlenmeyer flask, the following ingredients were added and stirred to form a stable monomer pre-emulsion composition, shown below.

Pre-emulsion Composition (grams)

| | |
|---|---|
| methyl methacrylate | 586.1 |
| butyl acrylate | 531.5 |
| methacrylic acid | 10.9 |
| N-(2-methacryloyloxyethyl) ethylene urea | 26.4 |
| deionized water (DI) | 398.0 |
| sodium dioctyl sulfosuccinate surfactant | 2.9 |
| (75% active) | |
| tristyrylphenol phosphate ester emulsifier | 46.8 |
| (20% active) | |
| anionic polyoxyethylene tridecyl phosphate | 10.8 |
| ester dispersant (25% active) | |
| ammonia hydroxide | 1.8 |

About 20 ml of 12.2% aqueous potassium persulfate (KPS) initiator solution and 70 g of the monomer pre-emulsion were charged to the reactor at 79° C. with constant agitation to form latex seeds. After about 20 minutes, the delay feed of the remaining monomer pre-emulsion together with 90 ml of 2.3% aqueous KPS initiator solution was fed to the reactor. The delay feed was completed in about 3 hours and maintained at 81° C. for another hour thereafter. The batch was then cooled down to 63-67° C., and the redox chasers, for example t-BHP and formaldehyde free SFS or other redox pairs, were used into the reactor to reduce the residual monomers. Ammonia hydroxide was added to adjust the final latex pH value. The latex batch was passed through a 140-mesh sieve screen to remove grits.

The latex to be used as binder resin for paint formulations discussed below had following properties:

| Solids | | Particle | | |
|---|---|---|---|---|
| % | MFFT | size | Mechanical stability | pH |
| 48.4% | 13.1 C. | 162 nm | Pass 30 min at 10,000 | 8.5 |
| | | | RPM agitation | |

RESIN 2. Into the same reactor setup as described in Example A1, 653 g of DI water, 1.5 g of sodium bicarbonate, and 2.2 g of sodium (C₁₄-C₁₆) olefin sulfonate emulsifier (40% active) were added. The reactor was heated to reach 79° C. and agitated at 190 RPM. The following ingredients were mixed together with proper agitation to form a stable monomer pre-emulsion.

Pre-emulsion Composition (grams)

| | |
|---|---|
| methyl methacrylate | 665.0 |
| butyl acrylate | 464.0 |
| 2-ethyl hexyl acrylate | 128.8 |
| methacrylic acid | 13.1 |
| N-(2-methacryloyloxyethyl) ethylene urea | 30.7 |
| DI water | 530.0 |
| anionic polyoxyethylene tridecyl phosphate | 23.6 |
| ester dispersant (25% active) | |
| tristyrylphenol phosphate ester emulsifier | 27.0 |
| (20% active) | |
| sodium C₁₄-C₁₆ olefin sulfonate anionic | 8.0 |
| surfactant (40% active) | |
| ammonia hydroxide | 2.2 |

About 68 g of this monomer pre-emulsion and about 20 ml of 12.0% aqueous potassium persulfate (KPS) initiator solution were charged into the reactor for seed formation. After 20 minutes of heating at 79° C. and after seed particles were formed, the rest of monomer pre emulsion, as well as 93 ml of 1.7% of potassium persulfate aqueous solution were fed into the reactor for about 3 hours. 1.4 g of hydroxyethylcellulose (HEC) was pre-dissolved into 56.0 g DI water which was added with the remaining 300 ml monomer emulsion towards the end of the delay feed. 16.0 g of surfactant (20% active) and 15.4 g of dispersant (25% active) were also added together with the HEC solution. The HEC grafting improve the latex mechanic stability and reduce the syneresis in paint formulation. After the monomer emulsion feed completed, the reactor temperature was held at 81° C. for another one hour and then cool down to 65° C. Redox pair chasers and ammonia hydroxide were added accordingly for residual monomers and pH control, respectively. The latex batch was passed through a 140-mesh sieve screen (0.105 mm or 0.0041 inch openings) to remove grits.

The latex to be used as binder resin for paint formulations discussed below has following properties:

| Solids | | Particle | | |
|---|---|---|---|---|
| % | MFFT | size | Mechanic stability | pH |
| 48.1% | 13.8 C. | 141 nm | Pass 30 min of 10,000 | 8.3 |
| | | | RPM stirring | |

Paint Formulations I-A and I-B:

A pigment grind with following ingredients with high RPM agitation was prepared.

| | |
|---|---|
| water | 119.0 parts |
| antimicrobial preservative | 1.0 parts |
| mildewcide | 1.0 parts |
| dispersant | 12.0 parts |
| defoamer agent | 1.0 parts |
| TiO₂ pigment | 290.0 parts |
| calcined aluminum silicate extender | 30.0 parts |
| diatomaceous earth filler extender | 20.0 parts |
| ceramic powder filler extender | 60.0 parts |
| acrylic suspension beads† | As needed |
| multifunctional amino alcohol | 2.0 parts |
| tristyrylphenol exthoxylate anionic surfactant | 5.0 parts |
| rheology modifier | 7.0 parts |

The agitation speed was set at high RPM for at least 10-15 minutes and then for several hours at lower RPM. The grind was checked occasionally and the RPM was adjusted accordingly to prevent grits formation.

After the above ingredients were made into smooth grind paste, the latex binders, coalescent agent, and other additives in the following table were added with good agitation to generate the paint samples for evaluation.

| | |
|---|---|
| emulsion latex binder (RESIN 1) | 385.0 parts |
| non-film forming synthetic pigment | 25.7 parts |
| open time additive | 40.0 parts |
| coalescent agent | 21.0 parts |
| foam control agent | 5.0 parts |
| rheology modifier | 10.0 parts |
| antifoaming agent type II | 1.0 parts |
| mixing for 10-15 minutes with good agitation | |
| water | 21.3 parts |

†90 parts of commercial MMA suspension copolymer beads (20 μm avg. particle size) without redox chasing was incorporated at the grind stage. The dry film properties are listed below as I-A1 and I-A2. The paint has strong monomer odor which was not suitable for commercial architectural coating application due to environmental and health concerns.
†A same loading of MMA suspension copolymer beads from Example 1 chased by redox pairs was incorporated at the grind stage. The dry film properties are listed below as I-B. The paint has no odor.

Paint Formulations I-3A and I-3B:

Making a grind with following ingredients with high RPM agitation.

| | |
|---|---|
| water | 16.0 parts |
| preservative | 2.0 parts |
| antimicrobial agent | 1.0 parts |
| dispersant | 10.0 parts |
| TiO₂ pigments | 210.0 parts |
| functional fillers/extender | 70.0 parts |
| calcined aluminum silicate extender | 50.0 parts |
| calcium carbonate extender | 45.0 parts |
| diatomaceous earth filler | 30.0 parts |
| acrylic suspension beads‡ | As needed |
| silica matting agent and fillers | 25.0 parts |
| antifoaming agent | 0.95 parts |
| anionic surfactant | 1.5 parts |
| high RPM agitation for at least 20 min | |
| and reduce to lower RPM | |
| anionic surfactant | 1.5 parts |
| nonionic surfactant | 6.0 parts |
| coalescent aid | 12.0 parts |
| water | 8.0 parts |
| thorough mixing for 15-20 min until | |
| the paste reach consistency. | |

The grind was admixed at the letdown stage with following latex binder and additives.

| | |
|---|---|
| emulsion latex binder (RESIN 1) | 325.0 parts |
| non-film forming synthetic pigment | 100.0 parts |
| rheology modifier | 16.5 parts |
| nonionic synthetic associative thickener | 6.0 parts |
| mix for 20 min with good agitation | |
| water | 68.2 parts |
| ammonia hydroxide | 0.38 parts |
| fungicide | 0.5 parts |
| maintain good mixing and add defoamer | 7.5 parts |
| water | 1.6 parts |

‡ Paint formulation I-3A has no added acrylic suspension beads
‡ Paint formulation I-3B has 7% or about 80 parts of redox chased suspension acrylic beads from Example 1 added.

Paint Formulation C:

The paint was made by incorporating 90 parts of the inventive redox chased, suspension acrylic beads (1-45 μm) in the grind paste with proper agitation and the let-down components were added thereafter. The suspension beads were treated with 0.13 wt. % of each redox in the pair (tBHP/formaldehyde free SFS) or 0.26% total at the end of the polymerization for about 60 minutes or longer before cooling down for filtration. Each half of the redox pair was added into the reactor individually at the end of the polymerization, and the remaining halves were added individually about 15 minutes later. The beads were collected through proper filtration and the monomer odors was eliminated with this treatment. The odor free suspension beads are suitable for architecture paint applications. The draw down films were evaluated for their dry film properties, and listed in the table below as paint formulation I-C.

Paint Formulation D:

The paint was made by incorporating 90 parts of acrylic beads with particle size range of 1-74 um, made by the suspension polymerization method with redox chasers discussed above and collected through proper mesh screen, in the grind paste with good agitation. The thinning down components were added similarly in the way in paint formulation C. The draw down paint film with 3-mil bar was evaluated for dry film properties. The results are listed as I-D. This was a comparative example with the particle size distribution outside of the preferred range to demonstrate that the paint surface was not acceptable due to the larger particle size distribution.

CONTROL PAINT FORMULATION The control paint was made by the same procedure as disclosed in paint formulation A with no acrylic suspension beads. The water/surfactant leaching, scrub and stain removal are all inferior comparing to those with acrylic beads.

The dry film properties of the paint formulations are discussed in the Tables 1 and 2 below.

TABLE 1

| | | | Total | | | |
|---|---|---|---|---|---|---|
| | Suspen. | | surfactant | Stains | | |
| Paint | beads | F/L | leaching | removal | Scrub | |
| Formulation | loading | (1-10) | (1-20) | rating | Cycles | Note |
| I-A1 | 7.8% | 6 | 20 | 4.52 | 1350 | Improved scrub and leaching |
| | | | | | | significantly but strong |
| | | | | | | monomer odors which was |
| | | | | | | not suitable for commercial |
| | | | | | | application. Commercial |
| | | | | | | acrylic beads from Arkema. |
| I-A2 | 7.8% | 8 | 20 | 7.2 | 1300 | Causing strong monomer |
| | | | | | | odors in the paint sample. |
| | | | | | | Commercial acrylic beads |
| | | | | | | from Arkema. |
| I-B | 7.8% | 9 | 20 | 6.0 | 1000 | No odor, redox pair added to |
| | | | | | | the suspension polymerization |
| | | | | | | step. Improved leaching and |
| | | | | | | scrub vs control |
| I-C | 7.8% | 9 | 20 | 5.7 | 1300 | No odor, redox chased |
| | | | | | | suspension beads (1-45 μm) |
| | | | | | | added. Significantly improved |
| | | | | | | leaching, and scrub. |
| I-D | 7.8% | 9 | 20 | 4.5 | 1000 | No odor, redox chased |
| | | | | | | suspension beads (1-74 μm) |
| | | | | | | added. Paint films have |
| | | | | | | visible grits. |
| Control | 0% | 7 | 15 | 8.7 | 747 | Visible water leaching. Poor |
| | | | | | | stain removal property. |

The test results show that paint formulations (I-A1 and I-A2) that incorporated the conventional non-chased, odorous suspension beads have improved scrubability (1300, 1350 cycles) over the control paint formulations with no suspension beads and stain removability over the controls. However, the associated odors prevent their use in architectural coatings, such as paints and stains. The inventive paint formulations (I-B and I-C) that incorporated the inventive redox-chased suspension beads have similar improved scrubability (1000-1300) and stain removability, but without the odors. Paint formulation (I-D) shows that the particle size distribution should not exceed the upper limit of about 45 μm to avoid grits. The larger particles may be suitable for other special effects for paints, for example where textured paint films are preferred.

All paint formulations that had the suspension beads exhibited good surfactant leaching properties compared to the controls. Emulsion polymerization requires surfactant(s) during the polymerization, as discussed above. After the latex particles are formed and made into paints, when paint films dried the surfactants are trapped in the resin matrix and can migrate to the surface and cause unsightly brown streaks. The flow leveling of the aqueous paints are also acceptable.

TABLE 2

| | | | Total | | | |
|---|---|---|---|---|---|---|
| | Suspen. | | surfactant | Stains | | |
| Paint | beads | Wet | leaching | removal | Scrub | |
| Formulation | loading | burnishing | (1-20) | rating | Cycles | Note |
| I-3A | 0% | 96.8% | 9 | 7.6 | 512 | Less desirable stain |
| | | | | | | removal and lower |
| | | | | | | scrubability. |
| I-3B | 7% | 11.1% | 17.5 | 2.3 | 1930 | Good paint surface |
| | | | | | | appearance. |

Paint formulations (I-3A and I-3B) both have silica matting agents and the inventive formulation (I-3B) also have the redox-chased suspension beads added thereto. These paint formulations show that the inventive paint formulation has superior scrubability and surfactant leaching property over the paint formulation without redox-chased suspension beads. The inventive formulation (I-3B) also resisted burnishing better showing a much lower percentage change in gloss/sheen after the same number of test cycles.

The present inventors believe that the reduction of surfactant leaching and the improved scrubability of the paint films can be contributed to the compatibility between the latex emulsion particles and the suspension beads, due similarities in their monomer compositions particularly the acrylic monomers in each. This property is also known in the polymer art as miscibility which means that the particles and beads are compatible and like each other resulting in stronger adhesion and cohesive bond between them. Better adhesion and/or cohesion resulted in lower microscopic gaps between the latex polymer matrix and the beads thereby reducing pathways for surfactant leaching and better adhesion to the beads for improved scrubability. Inorganic fillers, such as silica matting agents, are not as compatible or not as miscible with the latex polymer matrix and when added to paint compositions would be more susceptible to having more microscopic gaps and channels.

In one embodiment, the suspension bead loading in paint formulations ranges from about 7 wt. % to about 13 wt. % or about 70 lbs. to about 130 lbs. in 100 gallons of paints (about 950 lbs. to about 1100 lbs.) the amounts of residual monomers in paints attributable to the suspension beads would be about 50 ppm to about 120 ppm, preferably from about 60 ppm to about 110 ppm or from about 70 ppm to about 100 ppm.

Low VOC acrylic paints or paints made primary from acrylate monomers generally have less than about 200 ppm of unreacted monomers and other VOCs. Low VOC vinyl acrylic paints primary made from vinyl acetate and acrylate monomers generally have from about 1,000 ppm-2,000 ppm of unreacted monomers and other VOCs. Preferably, the paints or stains that incorporate the inventive low odor suspension beads would have the following levels of unreacted monomers and other VOCs. Substantially acrylic paints or stains should have less than about 350 ppm, preferably less than about 325 ppm or less than about 300 ppm of unreacted monomers and other VOCs. Vinyl acrylic paints or stains should have less than about 2000 ppm, preferably less than about 1750 ppm or less than about 1500 ppm of unreacted monomers and other VOCs. As used herein, acrylic paints or substantially acrylic paints contain at least about 95 wt. % acrylic latex polymers, and vinyl acrylic paints contain at least about 70 wt. % of vinyl acetate monomers in the latex polymers.

As used in the present patent application, the term “redox-chased suspension beads” is defined to mean beads having a particle size greater than 1 μm, made by suspension polymerization and preferably having an unreacted monomer count of less than about 1,000 ppm, preferably less than about 900 ppm or less than about 800 ppm or less than about 500 ppm or less than about 200 ppm. Redox-chased suspension beads also mean that the beads were made without the stripping step.

As used herein, substantially means at least 95 wt. %, preferably at least 97.5 wt. % and more preferably at least 99 wt. %.

### EXPERIMENTAL METHODS

Scrubability test shows the number of scrub cycles before failure and the test was conducted pursuant to ASTM D2486 Method B.

Surfactant leaching: surfactants or other water-soluble materials can leach from a paint film and causes a blotchy appearance or tan or brown spots to appear on the paint film when certain environmental conditions exist. Surfactant leaching is a test for probing the extent of exterior water spotting on a coating. The test method for surfactant leaching involved forming 3-mil draw down panels of each coating composition. These panels were then allowed to dry in air at about 72° F. and 50% RH for about 24 hours. Each panel was then held so that the coating on the substrate was oriented vertically, at which point 3-5 drops of water were applied over the coated area. Additionally, water is also sprayed on the panel. Without changing the orientation of the panels, the coatings were allowed to dry for 1 day and 7 days. The presence or absence of visible staining on each panel was noted and rated from 1 to 5, with 1 representing the most visible stain and with 5 representing no visible stain, for drops and sprays at 1 day and at 7 days. The maximum rating is 20.

The MPI stain removal test conducted in these experiments corresponds to the Master Paint Institute (MPI) COR-MTD-119 standard. Higher values indicate that the stains were more difficult to remove from the paint film. Lower values are more preferred. The numbers reported are the sum of the changes in color readings (Delta E values in CIE2000 units) of a pre-stained paint film and post-stained-and-washed paint film after a number of different stains are applied to the paint film. The stains include hot regular coffee, red cooking wine, tomato ketchup, yellow mustard and graphite. The cleaning solution comprises 0.5% nonyl phenoxy ethanol, 0.25% trisodium phosphate (TSP) and 99.25% deionized water. The cleaning solution is applied by a 430 g sponge/holder for 500 cycles. The changes of color caused by each stain are added and reported for each Example. This test is conducted at 72° F. and 50% RH. Alternatively, a less preferred and less stringent stain removal test, MPI COR-MTD-083, can also be used.

Flow leveling describes the textures of the paint film when dried, whether the film show brush marks or roller patterns. Flow leveling is measured at 25° C., according to ASTM Standard D4062-99, a scale of from 1 to 10, with 10 being the best flow/level characteristics. If the rheology profile is flawed such that the paint is too stiff, brush marks may be left when the paint is applied to a substrate.

Conversely, if the rheology profile of an aqueous latex paint is such that the paint is too thin, the paint may be drippy when applied to substrate, such that the point film will run unacceptably. This is known as “sag”, and the capacity of a paint to remain where applied rather than run or drip is called “sag resistance”. This property can be measured in different ways, but for purposes of the present invention is determined using a Leneta anti-sag matter. The higher the index number is, the better the sag resistance is. Different sag resistance may be dictated by different applications. In general, for architectural paints, an index number of 11 and above is considered to have excellent sag resistance. An index number from 8-10 has moderate or good sag resistance. An index number of 7 or below may cause significant drippings or running of paints on the substrates during application.

Burnishing is a tendency for a coating to increase its gloss or sheen due to rubbing or polishing. Anti-burnishing additives, e.g., the suspension beads in the present invention, are added to resist burnishing. Burnish resistance of latex paints can be ascertained in accordance to ASTM D6736, ASTM D523, ASTM D3924 and ASTM D2486 standards. The reported percentages are the changes between the initial and the after gloss/sheen values after certain scrub cycles.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

We claim:

1. A paint or stain aqueous composition comprising
an optional opacifying pigment,
a film forming latex resin, and
a redox-chased suspension bead having an unreacted monomer amount of less than about 1,000 ppm,
wherein the redox-chased suspension bead has a particle size (Dn) ranging from about 1 μm to about 45 μm,
wherein the redox-chased suspension bead comprises from about 3 wt. % to about 20 wt. % of the total polymer weight of the aqueous composition, and wherein the redox-chased bead is non-film forming.

2. The paint or stain aqueous composition of claim 1, wherein the particle size of the redox-chased suspension bead ranges from about 5 μm to about 35 μm.

3. The paint or stain aqueous composition of claim 2, wherein the particle size of the redox-chased suspension bead ranges from about 10 μm to about 30 μm.

4. The paint or stain aqueous composition of claim 1, wherein the particle size of the redox-chased suspension bead ranges from about 8 μm to about 12 μm.

5. The paint or stain aqueous composition of claim 1, the redox-chased suspension bead having an unreacted monomer amount of less than about 900 ppm.

6. The paint or stain aqueous composition of claim 5, the redox-chased suspension bead having an unreacted monomer amount of less than about 800 ppm.

7. The paint or stain aqueous composition of claim 6, the redox-chased suspension bead having an unreacted monomer amount of less than about 500 ppm.

8. The paint or stain aqueous composition of claim 1, wherein the redox-chased suspension bead comprises from about 4 wt. % to about 17 wt. % of the total polymer weight of the aqueous composition.

9. The paint or stain aqueous composition of claim 8, wherein the redox-chased suspension bead comprises from about 7 wt. % to about 14 wt. % of the total polymer weight of the aqueous composition.

10. The paint or stain aqueous composition of claim 1, wherein the redox-chased suspension bead is a matting agent.

11. The paint or stain aqueous composition of claim 1, wherein the redox-chased, suspension bead and the film forming latex resin are compatible with each other.

12. The paint or stain aqueous composition for claim 11, wherein the redox-chased, suspension bead and the film forming latex resin both comprise at least one acrylic monomer.

13. A paint or stain aqueous composition comprising
an optional opacifying pigment,
a film forming latex resin, and,
a redox-chased, suspension bead,
wherein the bead has particle size (Dn) ranging from about 1 μm-about 45 μm,
wherein the redox-chased bead comprises from about 3% to about 20% of the total polymer weight of the aqueous composition, and wherein the redox-chased bead is non-film forming, and
wherein the paint or stain composition comprises an unreacted monomer amount of less than about 350 ppm if the film forming latex resin comprises substantially acrylic latex particles, or wherein the paint or stain composition comprises an unreacted monomer amount of less than about 2,000 ppm if the film forming latex resin comprises vinyl acrylic latex particles.

14. The paint or stain aqueous composition of claim 13, wherein the paint or stain composition comprises an unreacted monomer amount of less than about 325 ppm if the film forming latex resin comprises substantially acrylic latex particles, or wherein the paint or stain composition comprises an unreacted monomer amount of less than about 1,750 ppm if the film forming latex resin comprises vinyl acrylic latex particles.

15. The paint or stain aqueous composition of claim 14, wherein the paint or stain composition comprises an unreacted monomer amount of less than about 300 ppm if the film forming latex resin comprises substantially acrylic latex particles, or wherein the paint or stain composition comprises an unreacted monomer amount of less than about 1,500 ppm if the film forming latex resin comprises vinyl acrylic latex particles.

16. The paint or stain aqueous composition of claim 13, wherein the redox-chased suspension bead is a matting agent.

17. The paint or stain aqueous composition of claim 13, wherein the redox-chased, suspension bead and the film forming latex resin are compatible with each other.

18. The paint or stain aqueous composition for claim 13, wherein the redox-chased, suspension bead and the film forming latex resin both comprise at least one acrylic monomer.
